(19) United States
(12) Patent Application Publication
(10) Pub. No.: US 2002/0075479 A1
(43) Pub. Date: Jun. 20, 2002

(54) Optical apparatus for testing liquid crystal (LC) devices

(76) Inventors: Randall J. Peck, Oceanside, CA (US); William G. Foote, Poway, CA (US)

Correspondence Address: LEONARD TACHNER, A PROFESSIONAL LAW CORPORATION, SUITE 38-E, 17961 SKY PARK CIRCLE, IRVINE, CA, 92614-6364, US

(21) Appl. No.: 10/016,637

(22) Filed: Oct. 30, 2001

Related U.S. Application Data
(60) Provisional application No. 60/244,668, filed on Oct. 31, 2000.

(51) Int. Cl. G01J 3/447

(52) U.S. Cl. 356/327

(57) ABSTRACT

An apparatus for testing critical design parameters in liquid crystal devices compensates for system-imposed influences on measured values, provides real-time correction for variations in spectral content of the source illumination and permits optimization of the values of control parameters.

### CROSS RELATED APPLICATIONS

This application takes priority from Provisional Patent Application Serial No. 60/244,668 filed Oct. 31, 2000.

### BACKGROUND OF THE INVENTION

1. Field of the Invention

The present invention relates generally to liquid crystal devices and more particularly, to an apparatus for testing such devices.

2. Background Art

When properly configured, the molecules comprising a Liquid Crystal (LC) material will be ordered such that their interaction with the E-field of plane-polarized light passing through the material will depend on the angle of the light's plane of polarization relative the ordering of the LC matrix. This refractive anisotropy is known as birefringence, and causes light to travel at two distinct speeds, depending on the direction of polarization. It also leads to LC materials' ability to serve as optical retarding media, i.e., they have the ability to rotate the plane of polarization of linearly-polarized light as it travels through an LC medium.

Because the LC's birefringence derives from the ordering of its molecules, any perturbation of this ordering can degrade the retarding ability of the LC material. Such perturbing forces include higher-than-optimal temperatures, as well as applied electrical fields. It is, in fact, the selective application of electrical field bias within a LC device that enables the presentation of information.

This effect becomes apparent when one illuminates and views a properly-configured LC device through linear polarizing media. If the device appears as an opaque object when no bias is applied, then it will appear as a relatively clear window with the application of appropriate bias, and vise versa. This relationship of clear/dark appearance depends on the angle of the illuminating polarizer to that of the viewing polarizer. An LC device illuminated with polarized light that is rotated 90 degrees by the LC material will appear dark when viewed through a linear polarizer at the same angle as the illuminating polarizer. The same device will appear bright if the viewing (or illuminating) polarizer is rotated 90 degrees.

If one properly configures the LC device, i.e., so that when electrical bias is applied (across the LC matrix), no rotation occurs, then the degree of “brightness” of the device under proper illumination/viewing conditions will be a function of the applied electrical bias. Thus, if electrical bias can be applied selectively over the plane of an LC device, information can be presented to an observer under the proper illumination/viewing conditions.

In general, an LC device's information-displaying ability derives from the spatial modulation of the birefringence of the LC material it contains.

From the above description, one can conclude that the amount of rotation of linearly-polarized light will depend on:

1. The “strength” of the LC material's birefringence; and

2. The thickness of the LC medium.

For LC devices that are intended for operation within a specified spectral band, it is critical that these three design parameters (birefringence, optical thickness, and spectral band of interest) be matched to achieve the desired performance effects.

In testing such LC devices, it is critical that a means be established to calibrate any systematic errors in measured values, including those due to “standards” that might be used in evaluating such devices.

Reflection-Mode LC Devices—Reflection-mode LC devices incorporate a mirrored surface situated beneath an LC matrix, so that in normal operation, light passing through the LC material, reflects off the backside mirror, passes once again through the LC material, and exits the device.

Testing Reflection-Mode LC Devices—Reflection-mode LC devices are commonly tested using a Polarizing Beam Splitter (PBS) cube as shown in FIG. 1. Light entering the PBS Cube from the Lamp (Leg 1 in FIG. 1) is split into two portions. That portion whose E-field is aligned with the polarization axis of the PBS Cube (Leg 2a in FIG. 1) is passed directly through the beam splitter (to illuminate the Test Site). That portion whose E-field is orthogonal to the polarization axis of the PBS Cube (Leg 2b in FIG. 1) is reflected at a right angle out the side of the beam splitter.

An object DUT positioned at the Test Site will be illuminated with linearly-polarized light that is aligned with the polarization axis of the PBS Cube. As this light passes through the LC medium, reflects off the back-side mirror, passes back through the LC medium, and exits the device, it will be rotated according to the birefringence of the LC material. Following its exit from the device, the light arrives at the PBS Cube (Leg 3 in FIG. 1) to once again be partitioned according to its polarization angle relative to the polarizer of the PBS Cube. This time, light that has not been polarization-rotated (Leg 4a in FIG. 1) will again pass straight through the PBS Cube. Light that has been rotated (Leg 4b in FIG. 1) will be reflected out the side of the PBS Cube to the Point of Measurement, where a camera or spectrometer probe may be placed for data acquisition.

Secondary Spectral Effects—A common technique calibrating a system used in testing reflection-mode LC device spectral characteristics is to place an “ideal” reflector (calibration standard) at the Test Site of FIG. 1 and measure its spectral reflectance characteristics. These measured characteristics then become the standard against which DUT-derived measurements are compared.

Since only light that is polarization-rotated relative to the polarization axis of the PBS Cube will be seen at the Point of Measurement, the calibration standard must both reflect light as well as rotate the light's angle of polarization, i.e., it must be a Polarization-Rotating Reflector. A first-surface mirror covered with a quarter-wave retarder is typically used in this role.

It is important to note that the rotation of polarization angle is a function of the light's wavelength, an effect we refer to as Optical Rotary Dispersion (ORD). In other words, a polarization rotator will not rotate all “colors” of light the same amount. Hence, light returning to the PBS Cube from a Polarization-Rotating Reflector (either a calibration standard or an LC device under test) will be rotated, and hence partitioned, according to its wavelength. Consequently, not all reflected light (apart from light at the wavelength for which the rotator is “tuned”) will be directed to the Point of Measurement; the portion of light arriving at the Point of Measurement being a function of its wavelength.

Also, the transfer functions of PBS Cubes and linear polarizing devices are typically wavelength-dependent.

Standard (“ideal”) spectral reflectance profiles acquired from measuring a Polarization-Rotating Reflector are therefore subject to salient “secondary” spectral effects if ORD is not accounted for in the calibration process.

The net result of using a Polarization-Rotating Reflector calibration standard whose ORD-derived contributions are not calibrated within the context of the system, is that all LC device measurements will be subject to the (systematic) errors present in the measured standard reflectance profile.

### SUMMARY OF THE INVENTION

Avoidance of Secondary Spectral Effects—It is a very difficult task to calibrate the secondary spectral effects that result from using a Polarization-Rotating Reflector calibration standard. The invention described herein provides a means of avoiding such secondary spectral effects in system calibration. The key feature of this approach is as follows:

1. A linear polarizer (rotated nominally 45 degrees off-axis from the PBS Cube) is inserted between the Test Site and the PBS Cube, causing light (both approaching and returning from the Test Site) to be partially rotated, thus facilitating delivery of some portion of reflected light to the point of measurement, even for a non-rotating reflector.

2. The spectral throughput of the system's individual legs of the optical path are measured both with and without the off-axis linear polarizer in the optical path, providing quantitative knowledge of the spectral contribution of the off-axis linear polarizer for both the approaching and returning optical path legs.

3. The spectral reflectance profile of a non-rotating first-surface (i.e., “ideal”) mirror is measured with the linear polarizer in the optical path. Corrections are then applied to account for the spectral contributions of the off-axis linear polarizer as quantified in 2 above producing a standard spectral reflectance profile that is independent of ORD-imposed spectral effects.

4. A means of selectively inserting the off-axis linear polarizer in the optical path is provided, allowing measurements with and without the off-axis linear polarizer in the optical path and hence provides:

a) A means of calibrating the spectral contributions of the off-axis linear polarizer;

b) Flexibility to measure both rotating and non-rotating reflecting surfaces.

A full treatment of the operating theory and calibration procedure for the invention is presented in the detailed description below.

Viewing Conflicts—LC device testing often requires both spectral characterization and detection of functional and cosmetic defects, which requires the acquisition of two-dimensional digital images by an electro-optic camera.

In addition, testing LC devices often requires machine vision assistance (i.e., the use of an electro-optic camera), for instance in locating alignment fiducials needed to facilitate certain system functions, including:

1. Material handling, e.g., properly placing the DUT at the test station;

2. Positioning test system components relative to the DUT, e.g., to establish electrical contact with the DUT;

3. Calibrating system components, e.g., measuring motion characteristics of moving parts and precisely locating contact probes.

These observations infer that there are two inherent “viewing conflicts” to be resolved in designing a system for testing LC devices. Specifically:

1. Two-dimensional digital images (camera-acquired) are required for both polarization-rotating objects (i.e., LC device display area) and non-polarization-rotating objects (e.g., calibration and device fiducials).

2. Both a camera and a spectrometer probe must have access to the Point of Measurement.

As noted above, with of the strategic placement an off-axis linear polarizer in the optical path we can expect to see light reflected from a non- polarization-rotating reflector at the Point of Measurement. By selectively inserting the off-axis linear polarizer we resolve Viewing Conflict 1, since it allows camera viewing of both polarization-rotating and non- polarization-rotating objects.

This invention also incorporates a means of selectively positioning either a spectrometer probe or a camera at the point of measurement, thus resolving Viewing Conflict 2.

Illumination Spectral Corrections—Since reflection is a measure of reflected light relative to incident light, one must account for the spectral characteristics of the illuminating source.

The invention described herein provides a means of providing real-time correction for variations in spectral content of the illumination source by simultaneously measuring the spectral profiles of both the illumination lamp and DUT-reflected light and using the former to normalize the latter.

DUT Control Parameters and Optical Performance—Depending on the particular design, an LC device's optical performance will be sensitive to the configuration of various control parameters such as bias voltage levels and control signal frequencies. Typical performance effects include optical instabilities which are seen as “flickering” of the LC display.

The invention described herein provides a means of measuring an LC device's optical performance as a function of various control parameters, and for the optimization of said control parameter values.

### OBJECTS OF THE INVENTION

The principal object of the present invention is to provide an apparatus for testing critical design parameters in liquid crystal devices while compensating for system-imposed influences on measured values.

Another object of the invention is to provide real-time correction for variations in spectral content of an illumination source in testing LC devices.

Still another object of the invention is to selectively position different measuring devices at the point of measurement in testing LC devices.

Yet another object of the present invention is to provide an apparatus for measuring an LC device's optical performance as a function of various control parameters and for optimization of the values of such control parameters.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1 is a diagram of a prior art apparatus used for testing reflection-mode liquid crystal devices;

FIG. 2 is a diagram of a preferred embodiment of the invention shown in a first configuration;

FIG. 3 is a diagram similar to FIG. 2, but showing a second configuration;

FIG. 4 is a diagram similar to FIG. 2, but showing a third configuration;

FIG. 5 is a diagram similar to FIG. 2, but showing a fourth configuration;

FIG. 6 is a diagram illustrating measurement of device reflectance;

FIG. 7 is a diagram illustrating measurement of reference spectrum;

FIG. 8 is a diagram illustrating calibration of P-polarization of the off-axis linear polarizer; and

FIG. 9 is a diagram illustrating calibration of S-polarization of the off-axis linear polarizer.

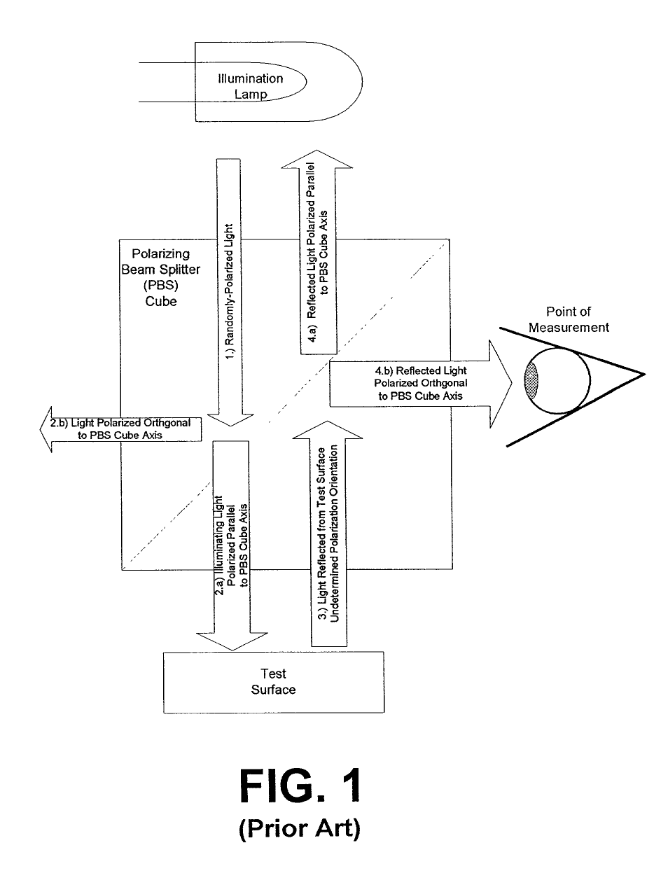

### DESCRIPTION OF A PREFERRED EMBODIMENT

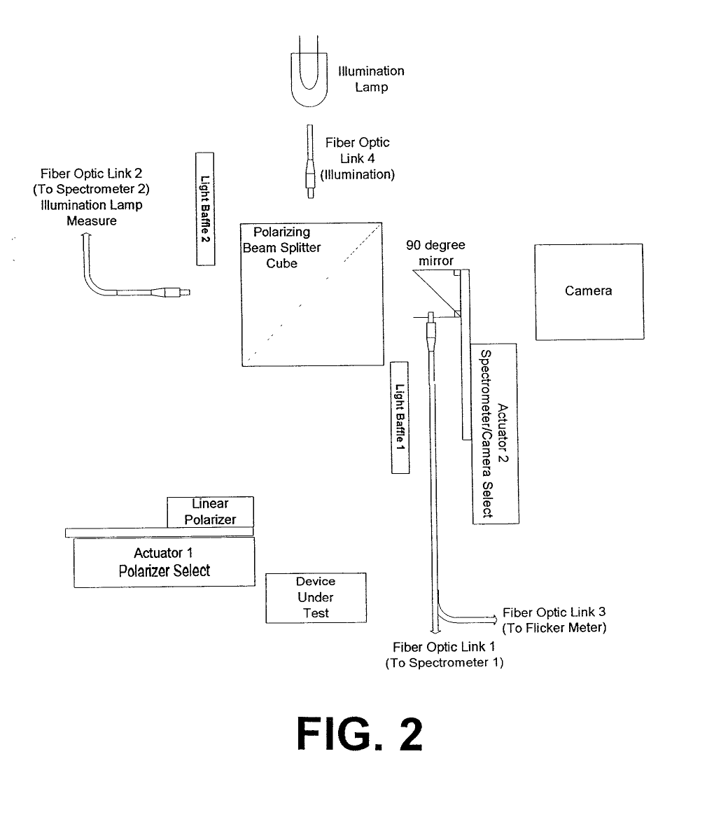

FIGS. 2 through 5 show the key components of an embodiment of the invention tailored for use in testing reflective mode LC devices. Optical lenses, mounting hardware, and control signal wires, etc. have been omitted for clarity. Each FIG. depicts a different use scenario.

The embodiment includes four measurement devices, including two spectrometers (Spectrometer 1 and Spectrometer 2), a Flicker Meter, and a Camera. An Illumination Lamp is used to illuminate the Device Under Test (DUT) through a Polarizing Beam Splitter (PBS) Cube.

Fiber Optic Links 1 through 4 deliver light from the Lamp to the DUT and from the DUT to Spectrometers 1 and 2 and the Flicker Meter.

A 90 Degree turning Mirror is shown as a means of directing light to the Flicker Meter and Spectrometer 1 through Fiber Optic Links 1 and 3.

The embodiment contains two actuators that are capable of positioning optical components in or out of the optical paths. Actuator 1 selectively positions a Linear Polarizer in or out of the optical path at the DUT's surface. The Linear Polarizer is rotated so that its axis of polarization is nominally 45 degrees relative to that of the PBS cube.

Actuator 2 allows for viewing of the light exiting from the PBS Cube by either the Camera or the Flicker Meter and Spectrometer 1. It also positions the Fiber Optic Links 1 and 3 behind Light Baffle 1 and moves Light Baffle 2 into the viewing path of the Fiber Optic Link 2.

### Use of the Invention

Theory of operation and optical calibration procedures for the invention are described in detail in the operating theory and calibration procedure below. The calibration procedure provides a means of empirically determining the spectral transfer function of the system both with and without the off-axis linear polarizer in the optical path, thus allowing use of a non-polarization-rotating reflection calibration standard, and hence avoiding ORD-derived secondary spectral effects inherent in the use of a polarization-rotating reflection calibration standard.

In general, Spectrometer 1 measures the spectral content of DUT-reflected light, and Spectrometer 2 measures the spectral content of the Illumination Lamp.

The configuration shown in FIG. 2 (Spectrometers IN, Polarizer OUT) allows for the measuring of the spectral reflectance profile of a polarization-rotating device such as an LC device or a combination Optical Retarder/FSM that may be used as a transfer standard.

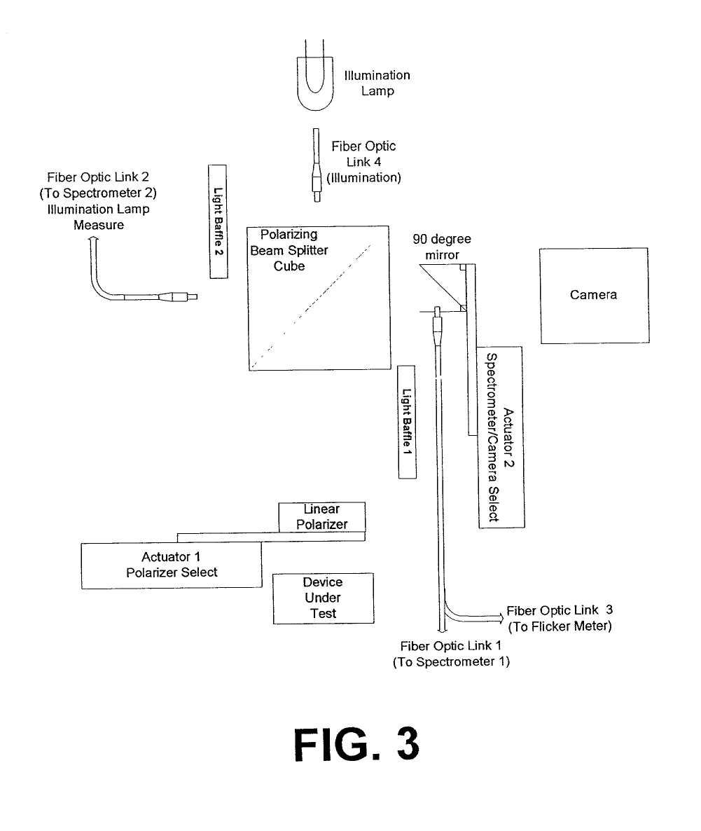

The configuration shown in FIG. 3 (Spectrometers IN, Polarizer IN) allows for the measuring of the spectral reflectance profile of a non-polarization-rotating device such as a First Surface Mirror (FSM). An FSM can be used as a nominally ideal reflecting standard against which measurements of an LC device can be compared in assessing its spectral reflectance profile. If the FSM's spectral reflectance profile is a NIST-traceable, then the measurement may be considered to be an absolute measurement; if not, it is to be regarded as relative to a transfer standard.

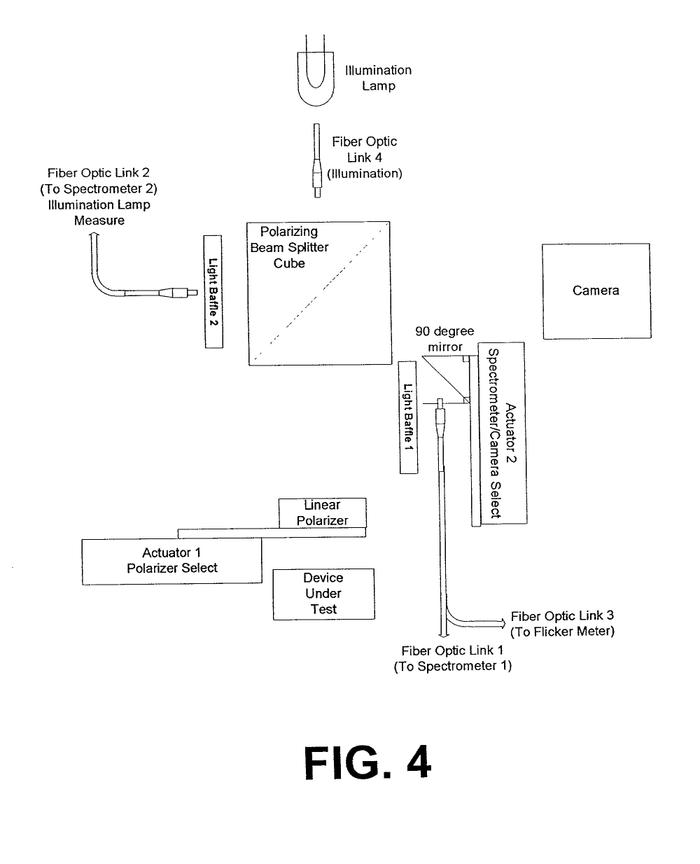

The configuration shown in FIG. 4 (Spectrometers OUT, Polarizer IN) allows for:

1. The measuring of spectrometer dark signal levels (i.e., any signal present in the spectrometer in the absence of light input) in Spectrometers 1 and 2;

2. The viewing of non-polarization-rotating surfaces by the Camera.

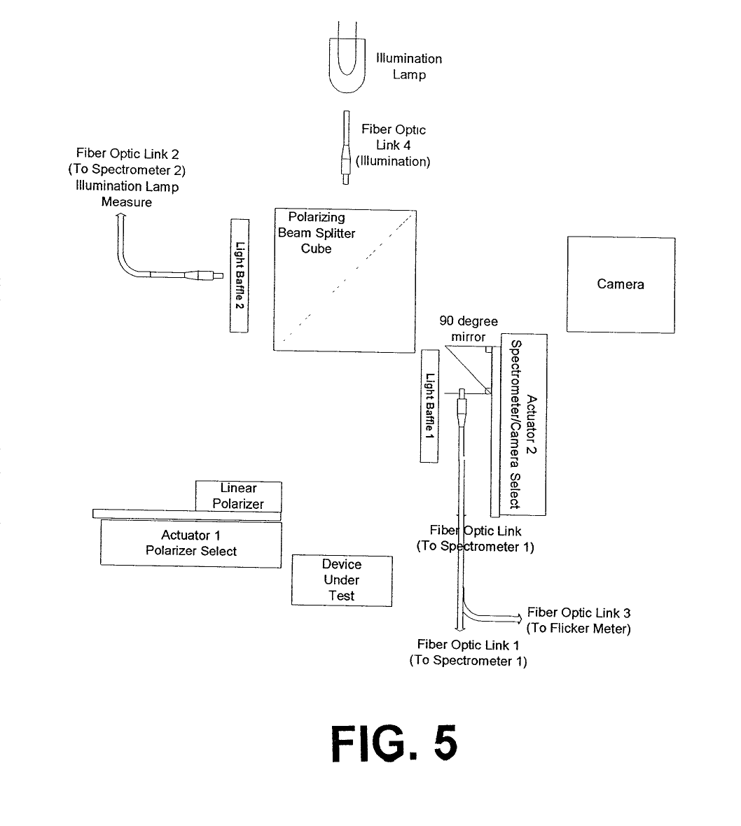

The configuration shown in FIG. 5 (Spectrometers OUT, Polarizer OUT) allows for:

1. The viewing of polarization-rotating surfaces (e.g., an LC device) by the Camera;

2. The measuring of spectrometer dark signal levels in Spectrometers 1 and 2.

### Operating Theory and Calibration Procedure

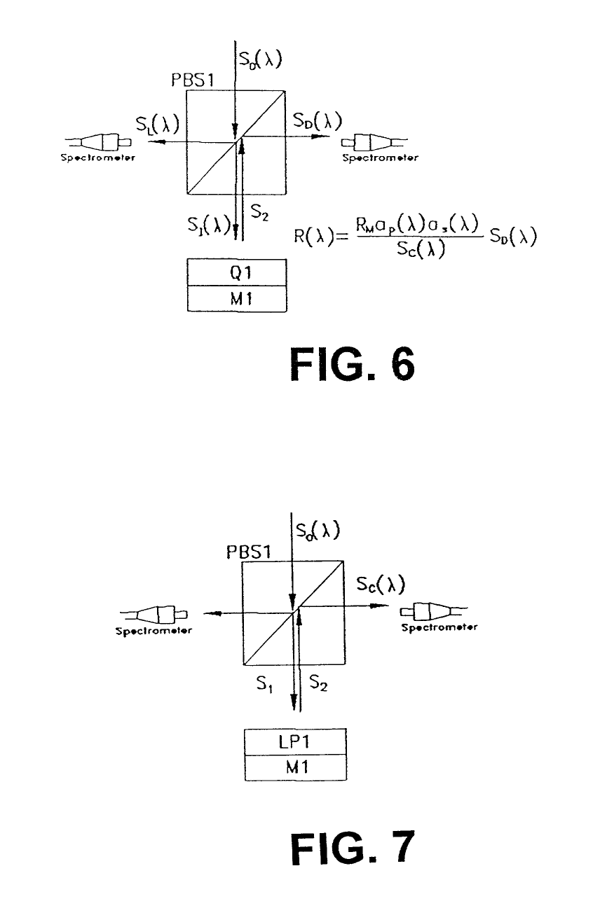

The operating theory and procedure for calibration of the polarization optics of the invention will now be described in conjunction with FIGS. 6-9.

A reflective mode LC device can be modeled as a perfect polarization rotator (¼-wave plate Q1 in FIG. 6) combined with an imperfect first-surface mirror (reflector M1 in FIG. 6).

Typically, such a device is illuminated with linearly polarized light, and then viewed through a crossed polarizer. A perfect device will rotate the polarization of the incident light exactly 90 degrees and will be 100% reflective. This combined effect will be referred to as a cross-reflectance in this document. Deviation from either 90 degree polarization rotation or 100% reflectance will result in a reduced cross-reflectance.

One task of the invention is to determine the cross-reflectance of an unknown Device Under Test (DUT).

All parameters used to characterize the devices described in this document are wavelength-dependent. In the interest of brevity, the wavelength dependence is not denoted in equations. For example, since reflectance is spectral, one would typically write R(λ) to denote R's dependence on λ. In this document, the (λ) is omitted and it is understood that all optical power measurements are spectral.

LAMP NORMALIZATION—As seen in FIGS. 6 through 9, the Polarizing Beam Splitter (PBS1) splits the non-polarized incident illumination (lamp output) into two orthogonally polarized paths. One path will be used to illuminate the DUT and the other path is used to provide a real-time measurement of the incident optical power (i.e., the Lamp Spectrum).

All spectrometer measurements will be normalized by (divided by) a Lamp Spectrum measurement made simultaneously with the test spectrum, providing real-time correction of changes in lamp output over time. The mathematical analysis that follows will omit this correction for the sake of brevity.

The polarization state of an electromagnetic wave can be represented by it's Jones Vector in the form:

$$\underline{E} = [ \begin{matrix}{E}_{p} \\ {E}_{s}\end{matrix} ]$$

where the underline signifies that the electric field (E-field) E is a vector, and the “p” and the “s” subscripts refer to the “p” and “s”-polarized components of E.

The Jones Matrix of a polarization device in general is given by a 2×2 matrix of coefficients, such that the effect of a polarization device on an incident E-field is given by:

E′=TE where

$$T = [ \begin{matrix}{T}_{00} & {T}_{01} \\ {T}_{10} & {T}_{11}\end{matrix} ]$$

The Jones Matrix for some common polarization devices include:

Linear Polarizer, optical axis aligned at some angle θ with respect to the x (p) axis:

$${T}_{L} = {α}^{1 / 2} [ \begin{matrix}{cos}^{2} θ & sin θcosθ \\ sin θcosθ & {sin}^{2} θ\end{matrix} ]$$

where α≦1 represents the efficiency.

Polarization Rotator:

$${T}_{PR} = [ \begin{matrix}cos θ & - sin θ \\ sin θ & cos θ\end{matrix} ]$$

Wave Retarder:

$${T}_{WR} = [ \begin{matrix}1 & 0 \\ 0 & {ⅇ}^{- jφ}\end{matrix} ] = [ \begin{matrix}1 & 0 \\ 0 & cos φ - j s in φ\end{matrix} ]$$

where θ=π/2 for a quarter-wave retarder, and θ=π for a half-wave retarder.

Virtually any polarizing device can be modeled as a sequential combination of the devices above, to provide the transformed E-field given the incident E-field.

The power in an electromagnetic wave is proportional to the square of the magnitude of the electric field:

Power=S=k||E||²=k(|Eₚ|²+|Eₛ|²)

We will deal with relative values of power and electric field only, so the multiplier K can be dropped and we can simply use the relation:

Power=S=||E||²=|Eₚ|²+|Eₛ|²=EₚE^{*}ₚ+EₛE^{*}ₛ(^{*}=Complex Conjugation)

The goal of the remainder of this analysis is to show how a linear polarizer, oriented at an angle of 45 degrees with respect to the polarization axes of the Polarizing Beam Splitter and DUT, can be used to characterize/calibrate an optical system for measuring the cross-reference of a polarization-rotating device such as an LCD (Liquid Crystal Device). Such a device is modeled as an imperfect reflector combined with a perfect quarter-wave plate. In the case of reflection from the surface of such a device, an incident E-field passes through the quarter-wave plate twice, such that the two-pass effect is that of a half-wave plate. In reality, such a device is not a perfect reflector, or a perfect polarization rotator (retarder), and the reflectance and retardation will both be a function of wavelength.

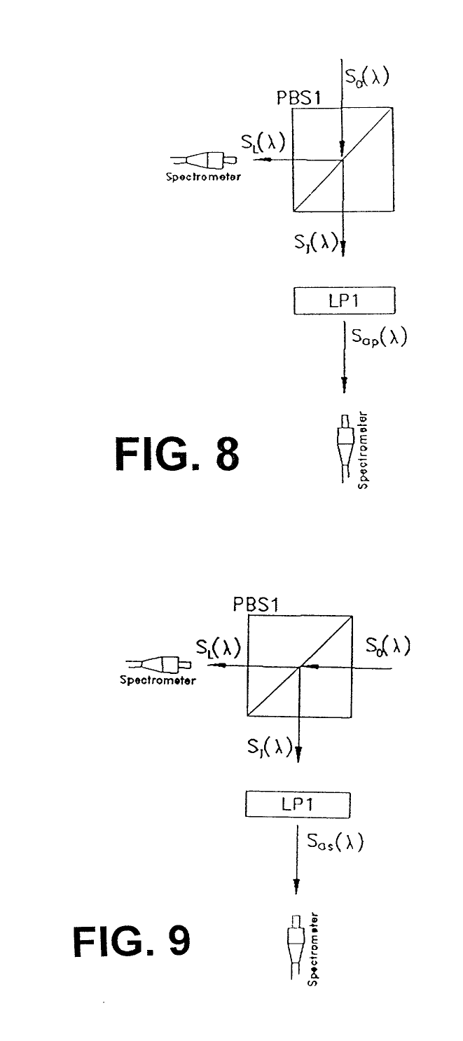

CALIBRATING THE LINEAR POLARIZER—Referring to FIG. 8, the illumination exiting the PBS (S_{I}) will be P-Polarized. The calibration task is to determine the transform matrix for the effects of the Linear Polarizer (LP1, on the transmitted E-field and therefore on the measured power S_{αp}(λ).

Before entering the Linear Polarizer LP1, the E-field can be represented by

$${\underline{E}}_{I} = {\underline{E}}_{I} = [ \begin{matrix}{E}_{I} \\ 0\end{matrix} ] ,$$

and the measured optical power is then S_{I}=||E_{I}||²=E_{I}².

Inserting the Linear Polarizer LP1, aligned at nominal angle of θ≈π/4 (45 degrees) with respect to the x-y (p-s) coordinate system, the E-field is given by:

$$\underline{E} = {T}_{L} [ \begin{matrix}{E}_{I} \\ 0\end{matrix} ] = {α}^{1 / 2} [ \begin{matrix}{cos}^{2} θ & sin θcosθ \\ sin θcosθ & {sin}^{2} θ\end{matrix} ] [ \begin{matrix}{E}_{I} \\ 0\end{matrix} ] = {α}^{1 / 2} [ \begin{matrix}{E}_{I} {cos}^{2} θ \\ {E}_{I} sin θcosθ\end{matrix} ]$$

and the measured power is S_{αp}=E_{I}²α(cos⁴θ+sin²θcos²θ)=E_{I}²αcos²θ

We can now define the term αₚ=αcos²θ=S_{αp}/S_{I}

The same process can now be performed on the other leg of the PBS. In this case, the Linear Polarizer LP1 is rotated by an angle π−θ relative to the polarizer ‘S’ axis. If we illuminate through the other leg of the PBS as shown in FIG. 8, it can be shown as above that:

α_{S}=αcos²(π−θ)=αsin²θ=S_{αS}/S₁

The last piece of calibration information required is the optical power reflected from a calibrated (first-surface) mirror M1, through the Linear Polarizer LP1.

Starting with the E-field at the exit from PBS1, and applying the Jones Matrix for each polarizing component in the optical path, we have at the input to the spectrometer pickup:

$${\underline{E}}_{c} = [ \begin{matrix}0 & 0 \\ 0 & 1\end{matrix} ] {α}^{1 / 2} [ \begin{matrix}{cos}^{2} θ & sin θcosθ \\ sin θcosθ & {sin}^{2} θ\end{matrix} ] {R}_{M} {α}^{1 / 2} [ \begin{matrix}{cos}^{2} θ & sin θcosθ \\ sin θcosθ & {sin}^{2} θ\end{matrix} ] [ \begin{matrix}{E}_{I} \\ 0\end{matrix} ]$$

$${\underline{E}}_{c} = {R}_{M} α [ \begin{matrix}0 & 0 \\ cos θsinθ & {sin}^{2} θ\end{matrix} ] [ \begin{matrix}{E}_{I} \\ 0\end{matrix} ] = {R}_{M} αcosθsinθ [ \begin{matrix}0 \\ {E}_{I}\end{matrix} ]$$

S_{C}=R_{M}α²cos²θsin²θE_{I}²=R_{M}α_{P}α_{S}E_{I}²

where the new term R_{M} is the spectral reflectance of the reference mirror.

DUT CROSS-REFLECTANCE, RD—Now, given FIG. 6, we can determine the reflectance of an unknown device.

Modeling the device as a perfect polarization rotator (¼-wave plate) over an imperfect reflector, the Jones Matrix is:

$${T}_{D} = {R}_{D} [ \begin{matrix}0 & - 1 \\ 1 & 0\end{matrix} ]$$

The E-field measured at the output of the PBS1 would then be:

$${\underline{E}}_{D} = [ \begin{matrix}0 & 0 \\ 0 & 1\end{matrix} ] {R}_{D} [ \begin{matrix}0 & - 1 \\ 1 & 0\end{matrix} ] [ \begin{matrix}{E}_{I} \\ 0\end{matrix} ] = {R}_{D} [ \begin{matrix}0 & 0 \\ 1 & 0\end{matrix} ] [ \begin{matrix}{E}_{I} \\ 0\end{matrix} ] = {R}_{D} [ \begin{matrix}0 \\ {E}_{I}\end{matrix} ]$$

and the measured power is:

$${S}_{D} = {R}_{D} {E}_{1}^{2} = \frac{{R}_{D} {S}_{C}}{{R}_{M} {α}_{p} {α}_{s}}$$

Solving for the desired DUT Reflectance:

$${R}_{D} = \frac{{R}_{M} {α}_{p} {α}_{s}}{{S}_{C}} {S}_{D}$$

If we accept the First-surface mirror as a perfect reference/transfer standard (R_{M}=1.0), we have our desired result:

$${R}_{D} = \frac{{α}_{p} {α}_{s}}{{S}_{C}} {S}_{D}$$

Having thus described an illustrative embodiment of the invention, it being understood that other embodiments which incorporate the inventive principles are contemplated and that the scope hereof is to be limited only by the appended claims and their equivalents, we claim:

1. An apparatus for testing reflective devices while compensating for imposed influences on measured values; the apparatus being used to evaluate a device under test (DUT) and comprising:
an illumination source;
a polarizing beam splitter for illumination by said source, said beam splitter having an axis and being located between said source and said DUT; said beam splitter providing transmission to source light of a first linear polarization parallel to said axis and 90 degrees reflection to light of a second polarization perpendicular to said axis; light of said first linear polarization reflected from a DUT and re-entering said beam splitter being transmitted through said beam splitter and light of said second linear polarization reflected from a DUT and re-entering said beam splitter being reflected in a measurement direction opposite to said 90 degrees reflected source light;
a first measurement device located in alignment with said beam splitter along said measurement direction; and
a linear polarizer selectively positioned on a path between said beam splitter and said DUT and having means to alter the position of said linear polarizer in said path and out of said path, said linear polarizer having a polarization axis which is substantially 45 degrees relative to a polarization axis of said illumination source.

2. The apparatus recited in claim 1, said first measurement device having means for measuring characteristics of said source light.

3. The apparatus recited in claim 1, said first measurement device having means for measuring spectrally-integrated light intensity.

4. The apparatus recited in claim 1 wherein said first measurement device comprises a spectrometer for determining spectral content of light.

5. The apparatus recited in claim 1 wherein said first measurement device comprises a camera for measuring spatial variations of light.

6. The apparatus recited in claim 1 further comprising a second measurement device, said second measurement device also positioned relative to said beam splitter along said measurement direction.

7. The apparatus recited in claim 6 wherein said first measurement device is a camera and said second measurement device is a spectrometer.

8. The apparatus recited in claim 6 wherein one of said first and second measurement devices is a camera and the other of said first and second measurement devices is a spectrometer.

9. The apparatus recited in claim 1 further comprising a spectrometer positioned relative to said beam splitter for receiving said 90 degrees reflected source light of said second polarization.

10. The apparatus recited in claim 4 further comprising a light baffle associated with said spectrometer.

11. The apparatus recited in claim 9 further comprising a light baffle associated with said spectrometer.

12. The apparatus recited in claim 6 wherein said second measurement device comprises a flicker meter.

13. The apparatus recited in claim 6 wherein one of said first and second measurement devices is a camera and the other of said first and second measurement devices is a flicker meter.

14. The apparatus recited in claim 1 wherein said reflective devices comprise liquid crystal devices.

15. An apparatus for testing reflective devices while compensating for imposed influences on measured values; the apparatus being used to evaluate a device under test (DUT) and comprising:
an illumination source;
a polarization filtering device;
a linear polarizer; and
a first measurement device;
said illumination source being positioned to provide an input beam to said filtering device;
said filtering device being configured to generate two orthogonally polarized first output beams from said input beam; said filtering device being positioned relative to a DUT to direct a selected one of said first output beams on said DUT and for receiving a reflected beam from said DUT; said filtering device being configured to generate two orthogonally polarized second output beams from said DUT reflected beam;
said first measurement device being positioned relative to said filtering device for receiving a selected one of said second output beams; and
said linear polarizer being selectively positioned on a path between said filtering device and said DUT and having means to alter the position of said linear polarizer in said path and out of said path, said linear polarizer having a polarization axis which is substantially 45 degrees relative to a polarization axis of said illumination source.

16. The apparatus recited in claim 15, said first measurement device having means for measuring characteristics of said source light.

17. The apparatus recited in claim 15, said first measurement device having means for measuring spectrally-integrated light intensity.

18. The apparatus recited in claim 15 wherein said first measurement device comprises a spectrometer for determining spectral content of light.

19. The apparatus recited in claim 15 wherein said first measurement device comprises a camera for measuring spatial variations of light.

20. The apparatus recited in claim 15 further comprising a second measurement device also positioned relative to said filtering device for receiving said selected one of said second output beams.

21. The apparatus recited in claim 20 wherein said first measurement device is a camera and said second measurement device is a spectrometer.

22. The apparatus recited in claim 20 wherein one of said first and second measurement devices is a camera and the other of said first and second measurement devices is a spectrometer.

23. The apparatus recited in claim 15 further comprising a spectrometer positioned relative to said filtering device for receiving the other of said second output beams.

24. The apparatus recited in claim 18 further comprising a light baffle associated with said spectrometer.

25. The apparatus recited in claim 23 further comprising a light baffle associated with said spectrometer.

26. The apparatus recited in claim 20 wherein said second measurement device comprises a flicker meter.

27. The apparatus recited in claim 20 wherein one of said first and second measurement devices is a camera and the other of said first and second measurement devices is a flicker meter.

28. The apparatus recited in claim 15 wherein said reflective devices comprise liquid crystal devices.
